(19) United States
(12) Patent Application Publication
(10) Pub. No.: US 2004/0233824 A1
(43) Pub. Date: Nov. 25, 2004

(54) Non-erasable optical data storage

(76) Inventors: Min Gu, Doncaster (AU); Daniel Day, Southlake, TX (US)

Correspondence Address: SUGHRUE MION, PLLC, 2100 PENNSYLVANIA AVENUE, N.W., SUITE 800, WASHINGTON, DC, 20037, US

(21) Appl. No.: 10/477,409

(22) PCT Filed: May 14, 2002
(86) PCT No.: PCT/AU02/00589

(30) Foreign Application Priority Data
May 14, 2001 (AU) PR 4965

(51) Int. Cl. G11B 7/00

(52) U.S. Cl. 369/116; 430/270.13; 369/118

(57) ABSTRACT

The invention relates to materials and devices including these materials having non-erasable optical data capability, as well as to methods of storing optical data and to apparatus for carrying out these functions. In particular there is provided a method of storage of non-erasable optical data comprising exposing data storage material of a three-dimensional optical data storage device to focussed electromagnetic radiation wherein the radiation is of a wavelength and power appropriate to generate micro-cavity formation within the data storage material and wherein the location of micro-cavities encodes for stored data; the data storage material comprising a polymer matrix and a photosensitive agent dispersed through the polymer matrix.

### FIELD OF THE INVENTION

The present invention relates to materials and devices including these materials having non-erasable optical data storage capability, and in particular, but not exclusively, to materials and devices that may be useful for storing optical data for archival purposes. The invention also relates to methods of storing and reading optical data and to apparatus for carrying out these functions.

### BACKGROUND OF THE INVENTION

The corporate and technology sectors of today have a high reliance on information technology (IT) systems. These IT systems place great demands on the capacity of current data storage devices. As such, an immense amount of research has been conducted in the field of three-dimensional optical data storage. Three-dimensional (3-D) optical data storage systems can achieve data densities in the order of 100 to 1000 times greater than conventional two-dimensional (2-D) data storage systems such as compact discs (CD) and digital versatile discs (DVD).

U.S. Pat. No. 5,761,111 to Glezer and other publications by the same author [1,2] have reported the controlled production of greater-than micron-scale, micron-scale and sub-micron-scale crack-free and regularly-shaped structures of altered refractive index within transparent data storage media. The formation of cavities within transparent storage media by focussing ultra-short laser pulses within the bulk of the media is a result of the non-linear interaction between the illumination light and the transparent medium. The medium is considered as “transparent” as it demonstrates no absorption at the illumination wavelength [2]. The absorption of high energy from a focussed beam ionises the material and produces a plasma gas. Due to the high temperature and pressure resulting from the plasma, a micro-explosion takes place in the focal region. The structure produced has a central volume of less dense material (typically a void), surrounded by a region of higher density material [1,2]. It was shown by Glezer and his colleagues that micro-cavities could be arranged in a three-dimensional (3-D) array for high-density non-erasable bit optical data storage of 17 Gbits/cm³ [1]. Recently, it has been noted that the formation of micro-cavities in silica change the chemical structure of the material immediately surrounding the cavity, which allows the readout of the 3-D data array of micro-cavities by measuring photoluminescence [3] and two-photon fluorescence [4].

Although U.S. Pat. No. 5,761,111 has suggested that micro-cavities for optical data storage can be formed within any transparent insulated material, the present inventors have not found this to be the case. Indeed, although it is known to be possible to generate micro-cavities in many transparent materials such as silica, quartz and sapphire, [1,2] problems are often encountered with irregularity of micro-cavity shape, localised cracking and insufficient micro-cavity density, which make such materials unsuitable for optical data storage compatible with modem IT systems.

The present inventors have, however, identified that polymers similar to those disclosed in International patent publication No. WO 00/49465, which have in the past been used for 3-D erasable bit optical data storage [5] via two-photon excitation modulated refractive changes, can be used for generation of micro-cavities and as the basis for devices useful for storing both permanent as well as erasable/re-writable information. In contrast to previous work on cavity formation [1-4], the photoreactive polymers according to the present invention are not transparent, but exhibit strong absorption in the ultra-violet to visible region of the electromagnetic spectrum.

### SUMMARY OF THE INVENTION

According to one embodiment of the invention there is provided a method of storage of non-erasable optical data comprising exposing data storage material of a three-dimensional optical data storage device to focussed electromagnetic radiation wherein the radiation is of a wavelength and power appropriate to generate micro-cavity formation within the data storage material and wherein the location of micro-cavities encodes for stored data; the data storage material comprising a polymer matrix and a photosensitive agent dispersed through the polymer matrix.

According to another embodiment of the invention there is provided data storage material for non-erasable optical data storage, capable of having micro-cavities generated therein by exposure to focussed electromagnetic radiation of appropriate wavelength and power; the data storage material comprising a polymer matrix and a photosensitive agent dispersed through the polymer matrix.

In a still further embodiment of the invention there is provided a three-dimensional optical data storage device comprising the data storage material referred to above. Preferably the data storage device further comprises a substrate, on or about which the data storage material is located. Particularly preferably the three-dimensional optical data storage device is such that the substrate protectively encloses the data storage material, and wherein a region of the substrate allows transmission of electromagnetic radiation to and from the data storage material.

Preferably the polymer matrix comprises one or both of poly(N-vinylcarbazole) and poly(methylmethacrylate).

Preferably the photosensitive agent comprises one or both of 2,4,7-trinitro-9-fluorenone and 2,5-dimethyl-4-(p-nitrophenylazo) anisole.

In another preferred embodiment the data storage material further comprises one or more plasticiser dispersed through the polymer matrix.

In a further preferred aspect of the invention the plasticiser comprises N-ethylcarbazole.

The data storage material may comprise:

25 to 99.5% by weight of polymer matrix;

0.5 to 65% by weight of photosensitive agent; and

0 to 40% by weight of plasticiser.

Preferably the data storage material comprises poly(methylmethacrylate), 2,4,7-trinitro-9-fluorenone, 2,5-dimethyl-4-(p-nitrophenylazo) anisole and N-ethylcarbazole.

In another preferred aspect of the invention the data storage material comprises:

about 33% by weight poly(N-vinylcarbazole);

about 50% by weight 2,5-dimethyl-4-N-nitrophenylazo anisole;

about 1% by weight 2,4,7-trinitro-9-fluorenone;

about 16% by weight N-ethylcarbazole.

In another preferred embodiment of the invention the data storage material comprises:

about 53% by weight poly(methylmethacrylate);

about 30% by weight 2,5-dimethyl-4-N-nitrophenylazo anisole;

about 1% by weight 2,4,7-trinitro-9-fluorenone;

about 16% by weight N-ethylcarbazole.

In another preferred aspect of the invention the data storage material comprises:

about 73% by weight poly(methylmethacrylate);

about 10% by weight 2,5-dimethyl-4-N-nitrophenylazo anisole;

about 1% by weight 2,4,7-trinitro-9-fluorenone;

about 16% by weight N-ethylcarbazole.

Preferably the electromagnetic radiation is pulsed infra-red laser radiation and preferably this radiation is at a wavelength of between about 750 nm and about 850 nm, particularly preferably at a wavelength of about 800 nm.

In preferred aspects of the invention the radiation power is between about 20 mW and about 40 mW, preferably between about 33 mW to about 38 mW, particularly preferably at about 35 mW.

Although the methods, devices and materials of the invention are preferably utilised for three-dimensional optical data storage, it is of course also possible for two-dimensional optical data storage to be achieved in the same maimer. Preferably the data is optical bit data, although it is also possible for the data to constitute a pattern, logo, image or indicia.

In another embodiment of the invention there is provided a method of reading optical data from a three-dimensional optical data storage device which comprises exposing data storage material of the device which has optical data stored therein to reading electromagnetic radiation of wavelength and power appropriate to optically differentiate micro-cavities from the remainder of data storage material and detecting the location of micro-cavities, wherein the location of micro-cavities encodes for stored data; the data storage material comprising a polymer matrix and a photosensitive agent dispersed through the polymer matrix.

Preferably the reading radiation is at a wavelength of between about 580 nm and about 880 nm, particularly preferably at a wavelength of about 632.8 nm. It is preferred for the reading radiation power to be between about 0.1 mW and about 5 mW, most preferably at about 2 mW. In an especially preferred embodiment of the invention the reading radiation is a He—Ne laser focussed through a reflection confocal microscope.

According to another aspect of the invention there is provided apparatus for storing optical data to, and reading optical data from, a data storage device, which apparatus comprises:

(i) means for retaining and locating the device;

(ii) a source of electromagnetic radiation at a wavelength and power appropriate to generate micro-cavity formation within data storage material of the device;

(iii) means for focusing the radiation to locations within the data storage material, wherein the location of micro-cavities encodes for stored data;

(iv) a source of reading electromagnetic radiation of wavelength and power appropriate to optically differentiate micro-cavities from remainder of data storage material;

(v) a sensor for detecting location of micro-cavities.

### BRIEF DESCRIPTION OF THE FIGURES

The invention will be described with reference to the figures wherein:

FIG. 1 shows transverse bit diameter as a function of the writing power. The points marked by a diamond indicate erasable data storage and the point marked by a circular spot corresponds to the formation of a micro-cavity. The numerical-aperture of the writing objective is 0.8.

FIG. 2 shows a single cavity formed in a photorefractive polymer. (a) and (b) are the transverse and axial images of the cavity in transmission microscopy, respectively, while (c) and (d) are the transverse and axial images of the cavity in reflection confocal microscopy, respectively.

FIG. 3 shows transmission images (FIGS. 3(a), (c) and (e)) and confocal reflection images (FIGS. 3(b), (d) and (f)) of an area of a photorefractive polymer following excitation for different exposure times.

FIG. 4 shows a plot of exposure time (ms) against both bit diameter (μm) and reflection confocal intensity (a.u.) for an area of a photorefractive polymer following excitation. Bits are examined in detail in the transmission microscopy (4(c), (d), (g), and (h)) and confocal reflection microscopy (4(a), (b), (e) and (f)) images.

FIG. 5 shows multi-layered micro-cavity arrays in a photorefractive polymer. The first layer including letter A is recorded near the surface and the second layer including letter B recorded with a separation of 20 μm in the depth direction. (a) and (b) are images in transmission microscopy while (c) and (d) are images in reflection confocal microscopy.

FIG. 6 shows multi-layered micro-cavity arrays in a photorefractive polymer. The first layer including letter A is recorded near the surface and the second layer including letter B recorded with a separation of 15 μm in the depth direction. FIGS. 6 (a) and (b) are the transmission and confocal reflection images, respectively, of the first layer of information. FIGS. 6 (c) and (d) are the transmission and confocal reflection images of the second layer. The spacing between bits is 6.5 μm.

FIG. 7 shows a diagrammatic representation of a recording/reading optical system according to the invention.

### DETAILED DESCRIPTION OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

The disclosures of all references referred to within this specification are included herein in their entirety.

In its broadest aspect the present invention relates to a three-dimensional optical data storage material. By the language “three-dimensional” it is intended to mean that the data storage material has the ability to store optical data in three dimensions through its volume. Naturally, the material of the invention may also be utilised for two-dimensional data storage, although this is not preferred. The data which may be stored on the devices of the invention may for example be binary digit or bit data that is converted from an electronic signal to an optical signal for storage. The read optical signal may then be converted back to an electronic signal. Processes for conversion of electronic signals to optical signals and visa versa are well recognised in the art.

In one aspect of the invention the device of the invention constitutes simply the data storage material itself which takes the form of a polymer matrix having photosensitive agent dispersed through it. In other embodiments of the invention, however, the three-dimensional optical data storage device may include a substrate onto which or about which the data storage material is located. For example the substrate may be glass, ceramic, plastics or other suitable, preferably inert material. Preferably the substrate will take the form of a protective coating surrounding or containing the data storage material. It is also preferred that at least a region of the substrate, in the case where it does surround or contain the data storage material, allows the transmission of electromagnetic radiation and in particular infra-red radiation. It may be the case that the data storage device of the invention takes the form of a card or disc which may conveniently be inserted into information technology equipment, such as computers, computer operated devices, hi-fi equipment, video equipment or the like. In such devices a transparent window may be provided within the cover through which data can be stored (written) or retrieved (read) to or from the device. For example, the devices of the invention may take the shape or configuration of conventional computer disks, CDs or DVDs. These possibilities are mentioned by way of example only and are not intended to be limiting upon the scope of the invention.

The key feature of the data storage devices according to the invention is the data storage material itself which constitutes a polymer matrix and a photosensitive material. Preferably the data storage material includes as a photosensitive material a chromophore or an agent including a chromophore moiety or moieties. The polymer matrix may be comprised of any polymer material characterised by low electromagnetic absorption in the wavelength range of 300 nm to 1080 nm, and which has suitable physical properties (eg. stability, workability, durability). Examples of suitable polymer matrices include poly (methyl methacrylate) (PMMA) and poly (vinyl carbazole). Preferably, the data storage material will include between about 25 weight percent and about 99.5 weight percent of polymer matrix. A preferred polymer matrix is PMMA.

The data storage material will include at least one photosensitive material. Such material will absorb radiation in the ultra-violet to visible region of the electromagnetic spectrum. Some examples of suitable photosensitive materials include 2,4,7-trinitro-9-fluorenone (TNF) and 2,5-dimethyl-4-(p-nitrophenylazo) anisole (DMNPAA, recognised as a chromophore compound). Preferably the data storage material includes photosensitive agents in an amount of between about 0.5 to about 65 weight percent. Preferably both TNF and DMNPAA are present, optimally in amounts of about 1 weight percent and about 30 weight percent, respectively.

It is also preferred that the data storage material will include a plasticiser which is compatible with the polymer matrix concerned. Appropriate plasticisers are well known in the art, and an example of a suitable plasticiser is N-ethylcarbazole. The plasticiser may for example be present within the data storage material in an amount of up to about 40 weight percent. The plasticiser will tend to reduce the glass transition temperature of the data storage material. If the plasticiser is N-ethylcarbazole, it is optimally present in an amount of about 16 weight percent.

It is also preferable that an initiator, such as for example benzoyl peroxide is used in preparation of the data storage material. The initiator provides the catalyst for polymerisation and is normally no longer present in the finished data storage retrieved. Other initiators which can be utilised are well known in the art. The data storage material according to the invention may additionally include other components routinely used in the polymer chemistry field.

One example of a new photorefractive polymeric material that has been used to demonstrate non-erasable 3-D bit optical data storage is the polymer poly (N-vinylcarbazole (PVK) doped with the photosensitive material 2,4,7-trinitro-9-fluorenone (TNF) which provides absorption in the UV to visible region of the spectrum. The photorefractive material also includes, as a chromophore, 2,5-dimethyl-4-(p-nitrophenylazo) anisole (DMNPAA) which also provides absorption in the UV to visible region. In producing the data storage material the randomly oriented chromophores are not aligned by applying an electric field (poling) during polymerisation and operation. Poling of the material requires the creation of a magnetic field across the surfaces of the polymer. Such a uniform magnetic field is difficult to maintain across the surface of a large polymer sample, increasing the complexity in fabricating the new photorefractive polymer. N-ethylcarbazole (ECZ) is added to reduce the glass transition temperature of the material. One preferred concentration of the materials DMNPAA:PVK:ECZ:TNF is 50:33:16:1 by percentage weight of the total weight of the photorefractive material, although it will be appreciated that different proportions of the constituent materials may be used within the ranges specified above. Uniforms films of desired thickness can be fabricated by combining all the materials in a teflon cast then polymerising the PVK at a temperature of 90° C. over 2 days. The resulting polymer block can then be cut and polished to produce the data storage material. By way of example only, thickness of 10 μm to 1.4 mm, preferably about 100 μm, may be adopted.

Another example of a new photorefractive polymeric material that has been used to demonstrate non-erasable 3-D bit optical data storage is the polymer poly(methylmethacrylate) (PMMA) doped with the photosensitive material 2,4,7-trinitro-9-fluorenone (TNF) which provides absorption in the UV to visible region of the spectrum. The photorefractive material also includes, as a chromophore, 2,5-dimethyl-4-(p-nitrophenylazo) anisole (DMNPAA) which also provides absorption in the UV to visible region. The randomly oriented chromophores were not aligned by applying an electric field (poling) during polymerisation and operation. Such a poling electric field is not necessary because the local electric field in the focus produced by a high numerical-aperture objective is five orders of magnitude greater than that of the incident beam over the objective aperture. This local electric field is strong enough to induce a detectable electro-optic effect.

N-ethylcarbazole (ECZ) may be added to reduce the glass transition temperature of the material. One preferred concentration of the materials DMNPAA:PMMA:ECZ:TNF used was 10:73:16:1 by percentage weight of the total weight of the photorefractive material. Another preferred concentration of these same materials is 30:53:16:1, although it will be appreciated that different proportions of the constituent materials may be used, but preferably within the ranges specified above.

The maximum of the absorption band of the data storage materials produced is within the range of 380-600 nm. Therefore a laser beam of an infra-red wavelength at 800 nm can be used in the recording process to produce multi-photon excitation, with these photorefractive materials. The wavelength for recording may fall substantially within the range from about 750 nm to about 1200 nm. In the case where the absorption band cuts off at a wavelength of approximately 630 nm, a range of wavelengths from about 630 nm to about 1200 nm can be chosen to read out the recorded photorefractive data bits without resulting in single-, two- or multi-photon excitation. Wavelengths above about 750 nm can be used for reading of recorded bits provided the power of the reading beam is sufficiently low to avoid causing single-, two- or multi-photon excitation.

The methods of the invention relate to the storage of “non-erasable” optical data in the sense that once optical data is stored to the photorefractive data storage material by the generation of micro-cavities, the structure and therefore photorefractivity of the material, is permanently altered. It is this characteristic that allows use of the data storage materials of the present invention for permanent data storage, as may for example be required for archival purposes or for IT products (eg. software, movies, sound recordings) that are made commercially available.

Optical data may be stored (written) to the data storage material by exposing the material to focussed electromagnetic radiation of an appropriate wavelength and power to generate micro-cavity formation. The data storage materials according to the invention demonstrate a material-dependent energy gap such that when subjected to focussed radiation above a threshold for the material, micro-cavities will be formed due to multi-photon excitation in the location of the focussed radiation. Although it of course depends upon the nature of the data storage material, it is preferred that the electromagnetic radiation constitutes pulsed infra-red laser radiation. Preferably the infra-red laser radiation is at a wavelength of between about 750 nm and about 850 nm, particularly preferably at a wavelength of about 800 nm. Radiation power of between about 20 mW and about 40 mW, preferably in the order of about 33 mW, may be utilised. Preferably the illumination will be provided by an ultra-short pulsed laser (for example a Spectra-physics Tsunami (TI-sapphire) femtosecond pulsed laser). Pulse widths of between about 20 and 220 fs, particularly preferably between about 60 and 100 fs and most particularly in the order of about 80 fs may be utilised, with a repetition rate of between about 10 to about 200 MHz, preferably between about 40 to about 100 MHz, particularly preferably about 70 to 90 MHz, most preferably about 82 MHz. The exposure times within the above illumination parameters may be varied according to the energy gap of the material concerned, but may for example be in the order of between about 5 to about 500 ms, preferably between about 10 and about 350 ms, more preferably between about 50 to about 300 ms, and particularly preferably about 250 ms. An objective lens (for example ULWD MSPlan 100-IR NA 0.80) may be utilised to focus the illumination to the desired zones of the data storage material. Objective lenses such as that referred to above are commercially available from Olympus and Carl Zeiss, Inc. Continuous wave (CW) multi-photon illumination may also be utilised.

To read data already stored to the data storage material the data storage material with optical data stored therein will be exposed to electromagnetic radiation of wavelength and power appropriate to optically differentiate micro-cavities from the remainder of the data storage material, and thereby detect the location of the micro-cavities which encode for stored data. The reading electromagnetic radiation will preferably be at wavelengths between about 580 nm and about 880 nm, most preferably at about 632.8 nm. It is important to ensure the power of the reading radiation is below that required for one-, two- or multi-photon excitation which leads to micro-cavity formation. Preferably, therefore, the reading radiation power is between about 0.1 mW and about 5 mW, most preferably about 2 mW. In a preferred embodiment of the invention the reading radiation is derived from a He—Ne laser, focussed through a reflection confocal microscope. However, micro-cavities can be detected using either transmission or reflection confocal microscopy. Reflection confocal microscopy is the preferred method as it has higher resolution in both the transverse and axial directions.

In a preferred embodiment of the invention the recording sample is translated in both the x and y directions through the focus of an objective in a confocal microscope, thereby producing an intensity image of the focal plane. The recording medium or reading objective is then translated in the z (axial) direction, thus positioning the focus deeper in the recording medium. The translation in the z direction is dictated by the layer separation used during recording. As either the top or bottom surface of a cavity passes through the focal spot, a signal is reflected back through the optical system and detected by a sensor such as a photomultiplier tube (PMT) or photodiode. The signal from one cavity corresponds to a single bit of recorded information.

In another preferred embodiment of the invention the recording sample is translated in both the x and y directions through the focus of an objective in a transmission microscope, thereby producing an intensity and phase image of the focal plane. The recording medium or reading objective is then translated in the z (axial) direction, thus positioning the focus deeper in the recording medium. The translation in the z direction is dictated by the layer separation used during recording. The light from the objective passes through the sample and is collected on the other side of the recording medium by another optical system, which sends it to a sensor, eg. the PMT or photodiode. As the light is scanned through each layer it undergoes a phase delay depending on whether it passes through a cavity or not. The combination of the phase and intensity profiles produce an image of the recorded cavities. The signal from one cavity corresponds to a single bit of recorded information.

In a preferred embodiment of the invention images of micro-cavities detected within the data storage material may be read using an Olympus FluoView microscope operating in a transmission mode. For example an objective that may be adopted for reading is an Olympus PlanApo oil-immersion objective with numerical-aperture 1.4 and a magnification factor of 60.

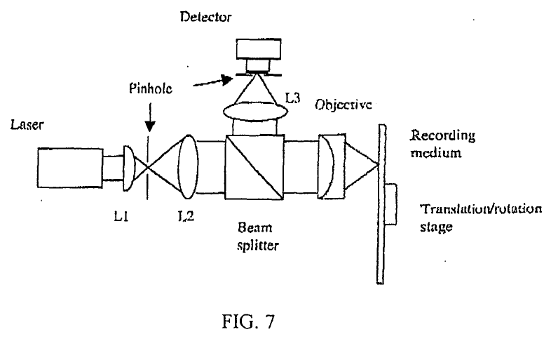

A diagrammatic representation of a recording/reading optical system of the invention is shown in FIG. 7. In the optical system shown in FIG. 7 the light from the laser or laser diode is collected by lens L1 and focused through a pinhole. Lens L2 then collimates the light, which passes through a beam splitter before being focused into the data storage material by the objective. For reading the reflected signals the light that is reflected from a cavity passes back through the objective and is reflected by the beam splitter. Lens L3 then focuses the light through a pinhole and onto a sensor such as a PMT or photodiode.

The present invention will be further described with reference to the following non-limiting experiments.

Experimental

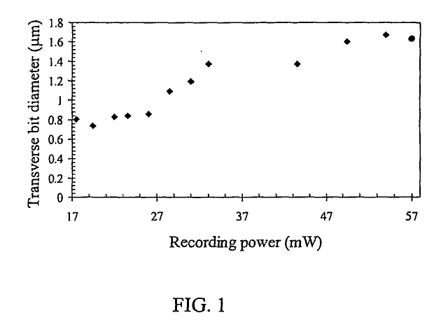

In recent work by the same inventor(s) an infra-red ultra-short pulsed laser beam was focussed by a high numerical-aperture objective on to a photorefractive polymer that has an absorption band in the ultraviolet (UV) and visible regions. Thus 3-D data bits can be recorded under two-photon excitation and erased with UV illumination. However, the inventors have now shown that the erasable/writable nature of the photorefractive effects exists only within a certain range of writing power. FIG. 1 shows an example of the dependence of the bit diameter on the writing power of a pulsed beam, indicating that a micro-cavity is formed via multi-photon absorption when the writing power is higher than 57 mW with an exposure time of 25 ms, for the particular photorefractive polymer tested. As a result of the formation of the cavity, the change in refractive index of the cavity is approximately 0.5, leading to the possibility of reading out a 3-D micro-cavity array using reflection-confocal microscopy [6,7].

The photorefractive material used consisted of the nonlinear chromophore 2,5-dimethyl-4-(p-nitrophenylazo)anisole (DMNPAA) (also considered as a photosensitive compound), the photosensitive compound 2,4,7-trinitro-9-fluorenone (TNF), the plasticiser N-ethylcarbazole (ECZ); all doped into the polymer poly(methylmethacrylate) (P The concentration of the different dopants DMNPAA:PMMA:ECZ:TNF was 30:53:16:1. In contrast to the previous work on cavity formation [1-4], the photorefractive polymer used in these experiments exhibits strong absorption in the ultra-violet to visible region of the spectrum.

The optical setup for creating micro-cavities was the same as that used for erasable 3-D optical data storage [5]. In order to create the high peak power for multi-photon excitation an ultra-short pulse laser (Spectra-physics, Tsunami) with a 10 W pump laser was used. The pulse width and repetition rate of the laser were 80 fs and 82 MHz, respectively. The cavity was produced by focusing the beam at wavelength 800 nm with power 33 mW through an objective with numerical aperture 0.8 and a magnification factor of 100. The exposure time required to form the cavity under the above conditions was 45 ms.

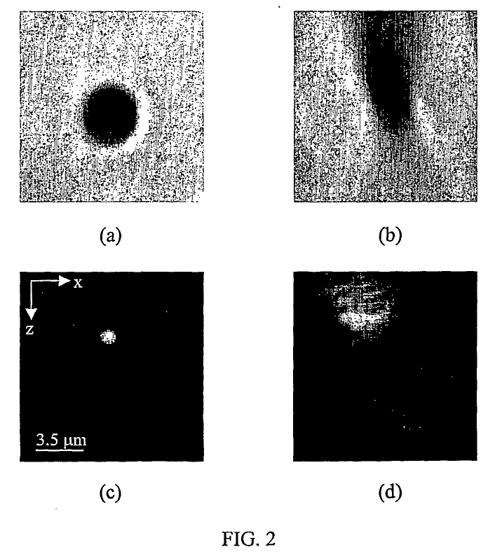

The transverse and axial images of a single micro-cavity were read using the Olympus FluoView microscope operating in a transmission mode are shown in FIGS. 2(a) and 2(b), respectively. A He—Ne laser was coupled to the microscope for reading as there is no absorption at a wavelength of 632.8 nm by the polymer sample. The objective used for reading was an Olympus PlanApo oil-immersion objective with numerical-aperture 1.4 and a magnification factor of 60. An average power less than 2 mW was used to produce the transmission images.

It can be seen from FIG. 2 that the central volume is surrounded by a region of the compressed material as indicated by the different intensities displayed in the image. The cavity featured in FIG. 2(a) is approximately 3.5 μm in diameter. The axial image (FIG. 2(b)) shows that it is indeed a cavity as there is a top and bottom surface. The same cavity was read in the Olympus microscope operating in reflection-mode confocal microscopy. The transverse confocal image (FIG. 2(c)) shows the reflection signal from the top surface (the polymer-air interface) of the cavity. Comparing the size of the cavity from FIG. 2(c) with that in the corresponding transmission image (FIG. 2(a)), one can see that the reflection confocal image shows a cavity that is smaller in diameter. This feature is due to the optical sectioning of confocal microscopy; only a small section of the cavity on the top surface is in the focal region, and therefore imaged on the detector. The imaging resolution of the reflection confocal microscope is approximately 0.5 μm and thus the size of the confocal image produced from a 3.5 μm-diameter micro-cavity should be approximately 1 μm, as shown in FIG. 2(c). In other words, a reflection image through the middle of the cavity, which would represent the the diameter of a cavity, is not possible, as there is no object to produce a reflected signal. The axial confocal scan of the cavity (see FIG. 2(d)) clearly shows both the top and bottom surfaces of the cavity. In this case both of the surfaces suffer from severe spherical aberration caused by the mismatch in refractive indices and exhibit strong side lobes associated with confocal axial scans [8].

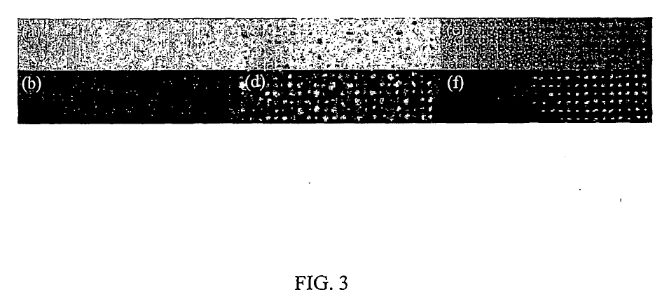

Under the conditions outlined above for creating microcavities (except with illumination power of 35 mW), the three types of the doped PMMA polymer (DMNPAA:PMMA:ECZ:TNF of 0:100:0:0, 10:73:16:1 and 30:53:16:1) were excited with different exposure times. FIG. 3 shows the transmission images (FIGS. 3(a), 3(c) and 3(e)) and the confocal reflection images (FIGS. 3(b), 3(d) and 3(f)) of the areas after excitation. Unlike the situation of Ref [9], no void could be created in the undoped PMMA polymer (FIGS. 3(a) and 3(b)) because there is no effective absorption at wavelength 800 nm even under multi-photon excitation. When the concentration of DMNPAA is increased, voids could be created but are not uniform for low concentrations (FIGS. 3(c) and 3(d)). In the highly doped PMMA polymer more uniform voids were fabricated successfully. In FIGS. 3(e) and 3(f), the bits (or voids) in each column were recorded with the same exposure time and the exposure time was varied from 10 ms (left) to 55 ms (right). As a result, the bits (or voids) on the right of the confocal image (FIG. 3(f)) show bright spots, while on the left no reflected signal is produced below a threshold of the exposure time.

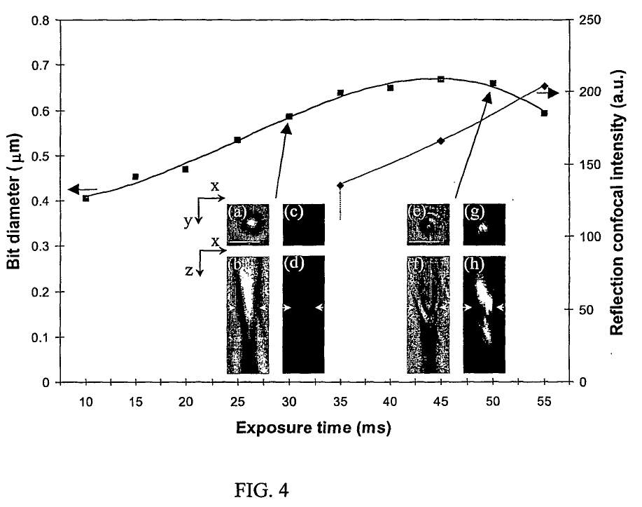

The threshold of the exposure time in the third type of the doped PMMA polymer is further demonstrated in FIG. 4 that shows the dependence of the diameter of the bits (or voids) and the reflection confocal intensity on the exposure time. The linear region of the bit-diameter curve in FIG. 4 represents the condition for melting [5], while the saturated region indicates that bits (or voids) are produced by micro-explosion processes. The reflection-intensity curve in FIG. 4 demonstrates that there is a threshold of the exposure time below which no confocal reflection signal is produced. This threshold therefore indicates where the energy deposited in the focal region is enough to create micro-explosion via multi-photon absorption. The energy corresponding to this threshold is 1.22 mJ of the employed laser, for the photorefractive polymer tested.

The bits (or voids) recorded below and above the threshold are examined in detail using transmission microscopy and confocal reflection microscopy, as shown in FIGS. 4(a)-4(h). At the shorter exposure time of 30 ms, i.e. below the threshold, the bit is formed as a result of melting of the polymer. The change in refractive index associated with a melted bit is not large enough to produce a reflection signal. Therefore an image of a melted bit obtained by reflection confocal microscopy shows nothing (see FIGS. 4(c) and 4(d)). However, when the recording exposure time is increased past a threshold, multi-photon ionisation of the doped polymer leads to micro-explosion in the material and results in the formation of a void. A void can be imaged using confocal reflection microscopy (see FIGS. 4(g) and 4(h)) as the change in refractive index between the void and the surrounding medium is significantly larger than that for a melted bit [7, 10, 11]. The axial confocal reflection scan of the void (see FIG. 4(h)) clearly shows both the top and bottom surfaces of the void. In this case both of the surfaces suffer from severe spherical aberration caused by the mismatch in refractive indices and exhibit strong side lobes associated with confocal axial scans [8.12].

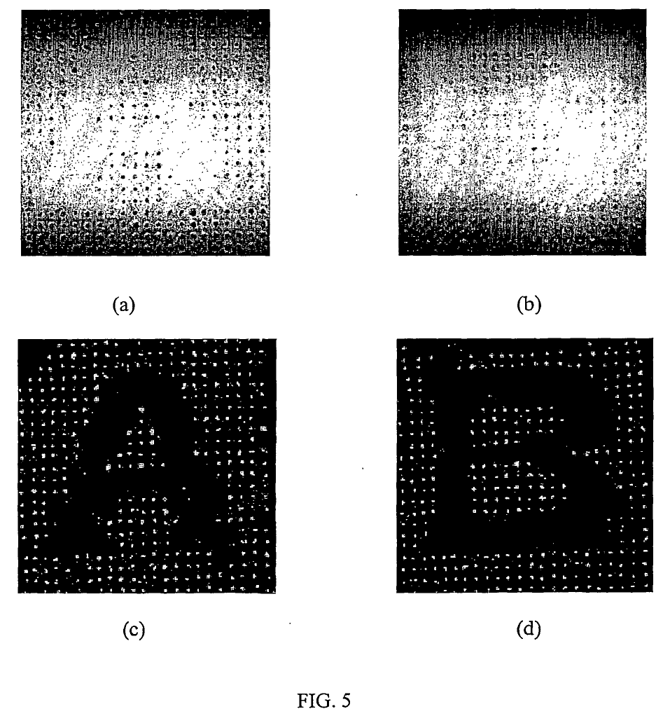

To demonstrate the feasibility of using microcavities in the photorefractive polymer for 3-D bit data storage [5,7,9], we illustrate in FIG. 5 two layers of micro-cavities recorded in the photorefractive polymer. The first layer is represented by the letter “A” (FIGS. 5(a) and 5(c)) and the second layer by the letter “B” (FIGS. 5(b) and 5(d)). The cavities were recorded and read using the same conditions as those for FIG. 2. However the exposure time for the second layer was increased to 290 ms in order to overcome the reduction in the intensity caused by spherical aberration resulting from the mismatch in refractive indices between the immersion and recording media [8]. The spacing between bits in a plane is 7 μm and the spacing between layers is 20 μm, which gives an equivalent 3-D storage density of 1 Gbits/cm³.

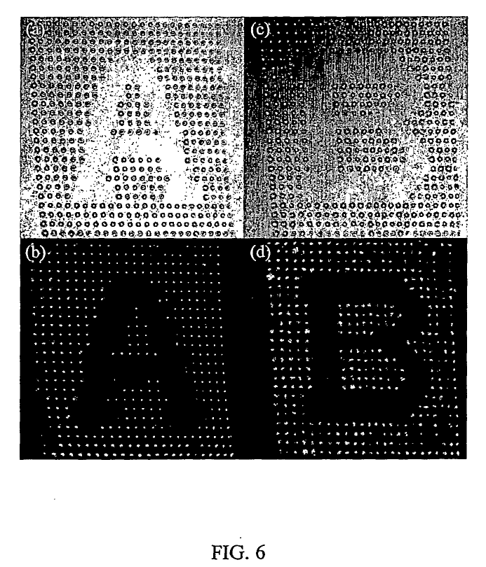

FIGS. 5(a) and 5(b) were obtained in the transmission microscope while FIGS. 5(c) and 5(d) were read using reflection confocal microscopy. Because of high axial resolution of confocal imaging, the cross talk from the neighbouring layers, as seen in the former case, does not appear in the latter. With the ability to read the cavities using reflection confocal microscopy, the layer separation could be reduced considerably without risking cross talk between any layers. An example of this is shown by the confocal and transmission images of FIG. 6 where the spacing between bits in a plane is 6.5 μm and the spacing between layers is 15 μm. These spacings could be reduced still further.

The cavities in our work were produced using ˜10⁴ shots of nJ in each pulse, whereas in the previous work they were generated using a single shot of μJ in each pulse [1-4]. Therefore, the present method gives less time for the electrons to lose energy before each of the pulses, which may increase the size of the cavities and thus reduce the storage density of the system. However, a high repetition rate may be useful for fast recording if the peak power is high enough to produce a cavity.

In conclusion, the inventors have demonstrated the formation of micro-cavities in a photorefractive polymer under multi-photon excitation. The ability to create micro-cavities allows for 3-D permanent optical data storage and the utilisation of reflection confocal microscopy for reading out the recorded information.

The inventors acknowledge the support from the Australia Research Council.

The present invention has been described by way of example only and it is to be understood that the invention is intended to include within its scope all modifications and alterations thereto that would be apparent to a skilled person based upon the disclosure provided herein.

References

[1] E. N. Glezer, M. Milosavljevic, J. Huang, R. J. Finlay, T.-H. Her, J. P. Callan and E. Mazur, Opt. Lett. 21, 2023-2025 (1996).

[2] E. N. Glezer and E. Mazur, Appl. Phys. Lett. 71, 882-884 (1997).

[3] M. Watanabe, S. Juodkazis, H.-B. Sun, S. Matsuo, H. Misawa, M. Miwa and R. Kaneko, Appl. Phys. Lett. 74, 3957-3959 (1999).

[4] M. Watanabe, S. Juodkazis, H.-B. Sun, S. Matsuo and H. Misawa, Appl. Phys. Lett. 77, 13-15 (2000).

[5] D. Day, M. Gu and A. Smallridge, Opt. Lett. 24, 948-950 (1999).

[6] M. Gu, Principles of three-dimensional imaging in confocal microscopy, World Scientific, Singapore, 1996.

[7] A. Toriumi, S. Kawata and M. Gu Opt. Lett., 23, 1924-1926 (1998).

[8] D. Day and M. Gu, Appl. Opt. 37, 6299-6304 (1998).

[9] K. Yamasaki, S. Joudkazis, M. Watanabe, H. -b. Sun, S. Matsuo and H. Misawa, Appl. Phys. Lett., 76, 1000 (2000).

[10] M. Gu, Principles of three-dimensional imaging in confocal microscopes, World Scientific, Singapore, 1996.

[11] M. Gu, J. O. Amistoso, A. Toriumi, M. Irie and S. Kawata, Appl. Phys. Lett., 79, 148 (2001).

[12] Y. Kawata, H. Ishitobi` and S. Kawata, Opt. Lett., 23, 756 (1998).

1. A method of storage of non-erasable optical data comprising exposing data storage material of a three-dimensional optical data storage device to focussed electromagnetic radiation wherein the radiation is of a wavelength and power appropriate to generate micro-cavity formation within the data storage material and wherein the location of micro-cavities encodes for stored data; the data storage material comprising a polymer matrix and a photosensitive agent dispersed through the polymer matrix.

2. The method according to claim 1 wherein the polymer matrix comprises one or both of poly(N-vinylcarbazole), and poly(methylmethacrylate).

3. The method according to claim 1 wherein the photosensitive agent comprises one or both of 2,4,7-trinitro-9-fluorenone and 2,5-dimethyl-4-(p-nitrophenylazo) anisole.

4. The method according to claim 1 wherein the data storage material further comprises one or more plasticiser dispersed through the polymer matrix.

5. The method according to claim 4 wherein the plasticiser comprises N-ethylcarbazole.

6. The method according to claim 4 wherein the data storage material comprises:
25 to 99.5% by weight of polymer matrix;
0.5 to 65% by weight of photosensitive agent; and
0 to 40% by weight of plasticiser.

7. The method according to claim 6 wherein the data storage material comprises poly(methylmethacrylate), 2,4,7-trinitro-9-fluorenone, 2,5-dimethyl-4-(p-nitrophenylazo) anisole and N-ethylcarbazole.

8. The method according to claim 7 wherein the data storage material comprises:
about 53% by weight poly(methylmethacrylate);
about 30% by weight 2,5-dimethyl-4-N-nitrophenylazo anisole;
about 1% by weight 2,4,7-trinitro-9-fluorenone;
about 16% by weight N-ethylcarbazole.

9. The method according to claim 1 wherein the electromagnetic radiation is pulsed infra-red laser radiation.

10. The method according to claim 9 wherein the pulsed infra-red laser radiation is at a wavelength of between about 750 nm and about 850 nm.

11. The method according to claim 10 wherein the pulsed infra-red laser radiation is at a wavelength of about 800 nm.

12. The method according to claim 9 wherein radiation power is between about 20 mW and about 40 mW.

13. The method according to claim 12 wherein radiation power is between about 33 mW to about 38 mW.

14. The method according to claim 1 wherein the data is optical bit data.

15. The method according to claim 1 wherein the data is a pattern, logo, image or indicia.

16. The method of reading optical data from a three-dimensional optical data storage device which comprises exposing data storage material of the device which has optical data stored therein to reading electromagnetic radiation of wavelength and power appropriate to optically differentiate micro-cavities from the remainder of data storage material and detecting the location of micro-cavities, wherein the location of micro-cavities encodes for stored data; the data storage material comprising a polymer matrix and a photosensitive agent dispersed through the polymer matrix.

17. The method according to claim 16 wherein the reading radiation is at a wavelength of between about 580 nm and about 880 nm.

18. The method according to claim 16 wherein the reading radiation is at a wavelength of about 632.8 nm.

19. The method according to claim 16 wherein reading radiation power is between about 0.1 mW and about 5 mW.

20. The method according to claim 16 wherein reading radiation power is about 2 mW.

21. The method according to claim 16 wherein the reading radiation is a He—Ne laser focussed through a reflection confocal microscope.

22. The method according to claim 21 wherein the polymer matrix comprises one or both of poly(N-vinylcarbazole) and poly(methylmethacrylate).

23. The method according to claim 21 wherein the photosensitive agent comprises one or both of 2,4,7-trinitro-9-fluorenone and 2,5-dimethyl-4-(p-nitrophenylazo) anisole.

24. The method according to claim 21 wherein the data storage material further comprises one or more plasticiser dispersed through the polymer matrix.

25. The method according to claim 24 wherein the plasticiser comprises N-ethylcarbazole.

26. The method according to claim 24 wherein the data storage material comprises:
25 to 99.5% by weight of polymer matrix;
0.5 to 65% by weight of photosensitive agent; and
0 to 40% by weight of plasticiser.

27. The method according to claim 26 wherein the data storage material comprises poly(methylmethacrylate), 2,4,7-trinitro-9-fluorenone, 2,5-dimethyl-4-(p-nitrophenylazo) anisole and N-ethylcarbazole.

28. The method according to claim 27 wherein the data storage material comprises:
about 53% by weight poly(methylmethacrylate);
about 30% by weight 2,5-dimethyl-4-N-nitrophenylazo anisole;
about 1% by weight 2,4,7-trinitro-9-fluorenone;
about 16% by weight N-ethylcarbazole.

29. Data storage material for non-erasable optical data storage, capable of having micro-cavities generated therein by exposure to focussed electromagnetic radiation of appropriate wavelength and power; the data storage material comprising a polymer matrix and a photosensitive agent dispersed through the polymer matrix.

30. The data storage material according to claim 29 wherein the polymer matrix comprises one or both of poly(N-vinylcarbazole) and poly(methylmethacrylate).

31. The data storage material according to claim 29 wherein the photosensitive agent comprises one or both of 2,4,7-trinitro-9-fluorenone and 2,5-dimethyl-4-(p-nitrophenylazo) anisole.

32. The data storage material according to claim 29 wherein the data storage material further comprises one or more plasticiser dispersed through the polymer matrix.

33. The data storage material according to claim 32 wherein the plasticiser comprises N-ethylcarbazole.

34. The data storage material according to claim 32 wherein the data storage material comprises:
25 to 99.5% by weight of polymer matrix;
0.5 to 65% by weight of photosensitive agent; and
0 to 40% by weight of plasticiser.

35. The data storage material according to claim 34 wherein the data storage material comprises poly(methylmethacrylate), 2,4,7-trinitro-9-fluorenone, 2,5-dimethyl-4-(p-nitrophenylazo) anisole and N-ethylcarbazole.

36. The data storage material according to claim 35 wherein the data storage material comprises:
about 53% by weight poly(methylmethacrylate);
about 30% by weight 2,5-dimethyl-4-N-nitrophenylazo anisole;
about 1% by weight 2,4,7-trinitro-9-fluorenone;
about 16% by weight N-ethylcarbazole.

37. A three-dimensional optical data storage device comprising data storage material according to claim 29.

38. A three-dimensional optical data storage device according to claim 37 further comprising a substrate, on or about which the data storage material is located.

39. The three-dimensional optical data storage device according to claim 38 wherein the substrate protectively encloses the data storage material and wherein at least a region of the substrate allows transmission of electromagnetic radiation to and from the data storage material.

40. The three-dimensional optical data storage device according to claim 39 wherein the region of the substrate allows transmission of radiation in the infra-red range.

41. Apparatus for storing optical data to, and reading optical data from, a data storage device, which apparatus comprises:
(i) means for retaining and locating the device;
(ii) a source of electromagnetic radiation at a wavelength and power appropriate to generate micro-cavity formation within data storage material of the device;
(iii) means for focusing the radiation to locations within the data storage material, wherein the location of micro-cavities encodes for stored data;
(iv) a source of reading electromagnetic radiation of wavelength and power appropriate to optically differentiate microcavities from remainder of data storage material;
(v) a sensor for detecting location of micro-cavities.
